(19) United States
(12) Patent Application Publication
(10) Pub. No.: US 2004/0109414 A1
(43) Pub. Date: Jun. 10, 2004

(54) Method of providing differentiated service based quality of service to voice over internet protocol packets on router

(76) Inventors: Gil Young Choi, Daejeon (KR); Jae Woo Park, Daejeon (KR); Kyou Ho Lee, Daejeon (KR); Mi Ryong Park, Daejeon (KR); Joo Myoung Seok, Daejeon (KR); Hyun Joo Kang, Kyungsangbook-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/674,253

(22) Filed: Sep. 29, 2003

(30) Foreign Application Priority Data
Dec. 10, 2002 (KR) 2002-78462

(51) Int. Cl. H04L 12/26

(52) U.S. Cl. 370/230

(57) ABSTRACT

The present invention provides a method of providing Differentiated Service (DiffServ) based Quality of Service (QoS) to Voice over Internet Protocol (VoIP) packets through a router. In the QoS providing method, VoIP call session information including source and destination IP addresses, source and destination user datagram protocol (UDP) port numbers, and requested QoS information is provided to the QoS control server by the VoIP call control device. Source and destination routers are found using the VoIP call session information and the VoIP call session information requiring provision of QoS is sent to the source and destination routers by the QoS control server. The present invention can recognize VoIP packets, provide QoS to the VoIP packets, and transmit voice packets of high quality.

### BACKGROUND OF THE INVENTION

1. Field of the Invention

The present invention relates generally to a method of providing Quality of Service (Qos) to Voice over Internet Protocol packets, and more particularly to a method of providing differentiated service based QoS to Voice over Internet Protocol packets on a switched router in the case of integrally handling voice traffics through an Internet Protocol network.

2. Description of the Prior Art

Voice over Internet Protocol (VoIP) is a term that designates Internet Protocol (IP) telephony technologies for a set of facilities that manage delivery of voice information using IP. In general, the VoIP means the protocol in which voice information is sent in digital form in discrete packets, rather than the traditional circuit-committed protocols like a Public Switched Telephone Network (PSTN). The VoIP is defined through the VoIP Forum by major equipment providers, such as Cisco, VocalTec, 3Com, NetSpeak, etc., so as to promote the use of International Telecommunications Union-Telecommunication Standardization Sector (ITU-T) H.323. The ITU-T H.323 is a standard for sending voice and video using IP on the public Internet or Intranets within companies. The VoIP Forum also promotes service standards so that users can locate other users and can use touch-tone signals for automatic call distribution and voice mail.

Such VoIP service technology has been introduced and developed as private network technology to provide a voice Virtual Private Network (VPN) subscribers for business use. Therefore, in order for a plurality of normal subscribers to be universally provided with VoIP services, several functions must be improved. Among the functions, the most important one is to provide QoS to subscribers. In order for VoIP to provide QoS, delay, delay variation and the like must be minimized. Further, in order for entire VoIP to provide QoS, the improvement of terminals is required, but, first of all, QoS of a network level must be provided. For providing QoS of a network level, a router constituting the network recognizes VoIP packets and assigns as high as possible QoS to the VoIP packets so as to provide QoS required by VoIP. However, due to the structure of IP, it is not easy for the router to classify VoIP packets, so it is difficult to provide QoS of a network level to the VoIP.

Therefore, research for supporting QoS requested by real-time application services, such as VoIP, has been conducted by the Internet Engineering Task Force (IETF). As a result, an Integrated Service (IntServ) model and resource Reservation Protocol (RSVP) have been developed. In the IntServ model, resource reservation is performed in advance using the RSVP by the user's packet flow generated in real-time applications. Further, the IntServ is classified into a QoS guaranteed service and a QoS best effort service, and provided to users. A method for providing IP telephony with QoS using end-to-end RSVP signaling is disclosed in U.S. Pat. No. 6,366,577 as a conventional method of providing QoS to VoIP on the basis of RSVP. However, in the case of a wideband backbone router in which several thousands to several tens of thousands of flows exist simultaneously, it is difficult to individually maintain and manage resource reservation states according to respective flows. Accordingly, the RSVP performing resource reservation by the flow is not suitable for a network with a large scale.

In order to solve the unsuitableness of the above-described RSVP based IntServ model, a standard relating to the structure of a Differentiated Service (DiffServ) model has been developed by the DiffServ working group of the IETF. The DiffServ model is designed to differentiate services by providing the services by the aggregate of user flows, not by the user flow. In the DiffServ model, the control of user packet flows is performed at the boundaries of a network. Further, when user packet flows flow into the network, the user packet flows are aggregated into a small number of traffic classes, so complicated packet processing within the network for supporting QoS is simplified. Unlike the IntServ model, the DiffServ model does not require a signaling protocol to maintain the states of the flows, as core routers within the network recognize individual user flows through the aggregation of the user flows. Further, the DiffServ model can be applied to a large scale network, because it can provide end-to-end services through only negotiation between networks even though a plurality of networks are connected with each other to provide services. A method of allocating DiffServ Code Point (DSCP) to improve voice packet processing ability is disclosed in Korean Pat. Appl. No. 2000-0077683 as a conventional method using the DiffServ model.

However, the conventional method of allocating the DSCP to improve voice packet processing ability is problematic in that, since it requires an additional device for determining a DSCP code only for DiffServ and preferentially processing the DSCP code, it cannot provide QoS of a network level to VoIP using a conventional router constituting a network.

### SUMMARY OF THE INVENTION

An object of the present invention is to provide a method of providing Differentiated Service (DiffServ) based Quality of Service (QoS) to Voice over Internet Protocol (VoIP) packets on a router, which can provide QoS of a network level to VoIP by providing DiffServ based QoS to VoIP using a conventional router, without requiring an additional device to integrally handle voice traffics through an IP network.

In order to accomplish the above object, the present invention provides a method of providing Differentiated Service (DiffServ) based Quality of Service (QoS) to Voice over Internet Protocol (VoIP) packets on a router in an Internet protocol (IP) network, the IP network comprising routers, a VoIP call control device for performing a call processing function on the basis of a VoIP signal, and a QoS control server for providing QoS, the method comprising the steps of a) providing VoIP call session information including source and destination IP addresses, source and destination user datagram protocol (UDP) port numbers, and requested QoS information to the QoS control server by the VoIP call control device; b) finding source and destination routers using the VoIP call session information and sending the VoIP call session information requiring provision of QoS to the source and destination routers by the QoS control server; and c) providing DiffServ based QoS to packet flows by the aggregate of packet flows using the VoIP call session information at the time of VoIP packet forwarding by the routers.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a DiffServ based IP network to which the present invention is applied;

FIG. 2 is a view showing the connection between elements in the DiffServ based IP network to which the present invention is applied;

FIG. 3 is a block diagram showing the configuration of a router to which the present invention is applied;

FIG. 4 is a detailed block diagram of a router control unit in the router according to the present invention;

FIG. 5 is a detailed block diagram of a switching platform in the router according to the present invention;

FIGS. 6A and 6B are flowcharts of a method of providing QoS to VoIP packets according to an embodiment of the present invention;

FIG. 7 is a data flow diagram showing the example of an open interface between the router control unit and the switching platform in the router according to the present invention;

FIGS. 8A, 8B and 8C are views showing the exemplary formats of an eGSMP message according to the present invention; and

FIG. 9 is a flowchart showing the operation of the router according to the present invention.

### DESCRIPTION OF THE PREFERRED EMBODIMENTS

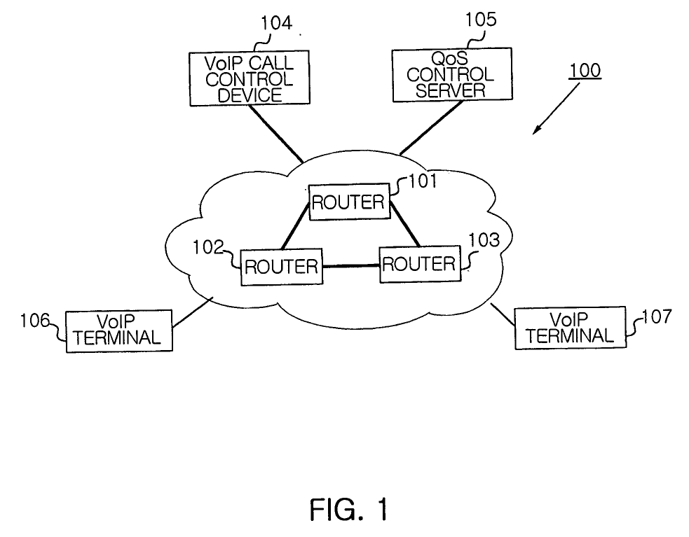

FIG. 1 is a view showing the configuration of a DiffServ based IP network to which the present invention is applied. The DiffServ based IP network 100 of the present invention comprises routers 101, 102 and 103, a VoIP call control device 104, a QoS control server 105 and terminals 106 and 107. The routers 101, 102 and 103 perform the function of routing among different sub-networks and the function of providing DiffServ based QoS. The VoIP call control device 104 is connected to the IP network 100 to perform the function of processing a call on the basis of VoIP signals such as session initiation protocol (SIP) and H.323. The QoS control server 105 provides QoS in the IP network 100.

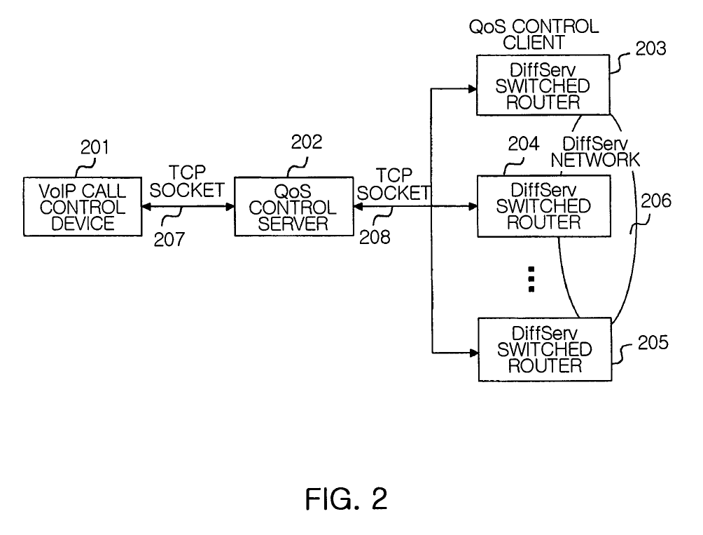

FIG. 2 is a view showing the connection between elements in the DiffServ based IP network to which the present invention is applied. Fundamentally, the connection between elements in the DiffServ based IP network of the present invention complies with a clients-server structure. A QoS control server 202 corresponds to a server in the clients-server structure, while a VoIP call control device 201 and the routers 203, 204 and 205 correspond to clients in the clients-server structure. Preferably, TCP sockets 207 and 208 are respectively utilized to connect the QoS control server 202 to the VoIP call control device 201 and the QoS control server 202 to all routers 203, 204 and 205 within the DiffServ network using well-known TCP port numbers via an open application programming interface to exchange QoS information.

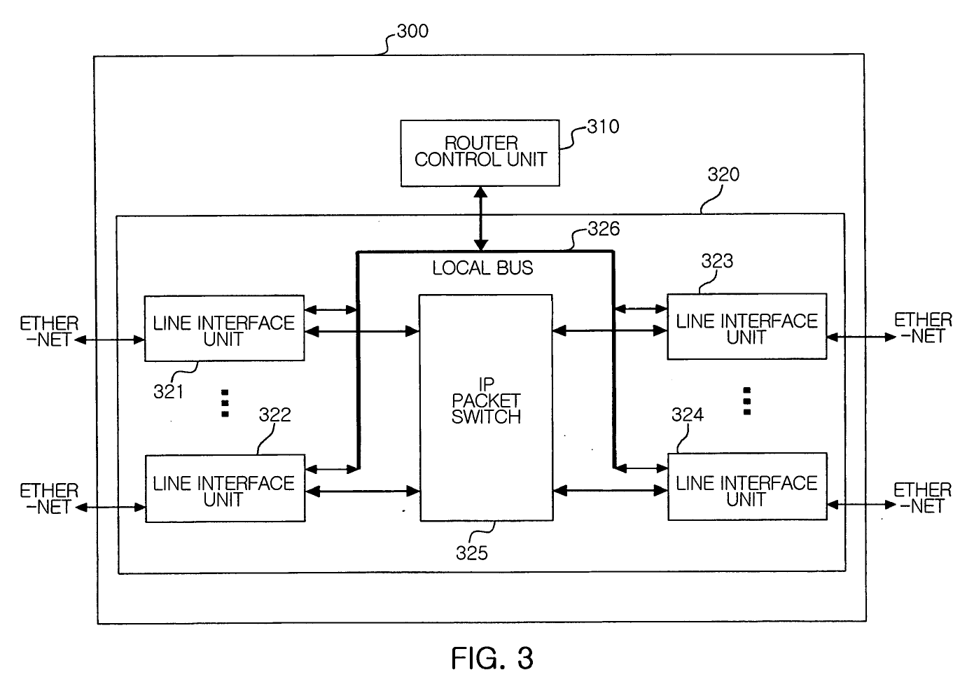

FIG. 3 is a view showing the configuration of a router to which the present invention is applied. The router to which the present invention is applied is preferably a DiffServ switched router. Further, a DiffServ switched router 300 of the present invention comprises a router control unit 310 and a switching platform 320. Further, the switching platform 320 includes a plurality of line interface units 321 to 324, and an IP packet switch 325. In order for the DiffServ switched router 300 to operate as a high speed router of several tens of gigabits, a routing function and a packet forwarding function are preferably separated. The router control unit 310 performs the function of a routing protocol used to set a routing path and the function of managing the operation of the router. The line interface units 321 to 324 in the switching platform 320 perform packet forwarding functions. The plural line interface units 321 to 324 are connected to the high speed IP packet switch 325. The router control unit 310 and the line interface units 321 to 324 are connected to each other through a local bus 326 in the router to mutually exchange information therebetween. In order to perform an open programmable interface function, the router control unit 310 functions as an enhanced General Switched Management Protocol (eGSMP) master, and the line interface units 321 to 324 each function as an eGSMP slave. Further, the line interface units 321 to 324 provide a plurality of physical interfaces in the format of 10/100 Mbps or gigabit Ethernet so as to communicate with the outside of the router. The eGSMP will be described later in detail.

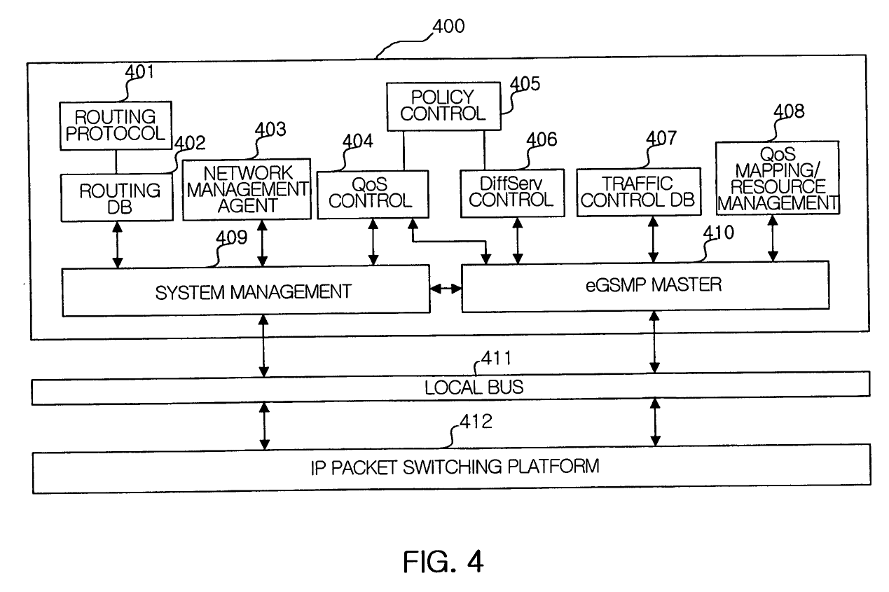

FIG. 4 is a detailed block diagram of the router control unit of FIG. 3. The router control unit 400 comprises an IP routing protocol unit 401 and a routing database (DB) unit 401. The IP routing protocol unit 401 performs the function of IP routing protocols, such as Routing Information Protocol (RIP), Open Shortest Path First (OSPF) and Border Gateway Protocol (BGP). The routing DB unit 402 maintains and manages a routing table in which routing information is recorded. Further, the router control unit 400 includes a network management agent unit 403, a QoS control unit 404, a DiffServ control unit 406, a policy based control unit 405, a traffic control DB unit 407, and a QoS mapping unit 408. The network management agent unit 403 functions as an agent for network management. The QoS control unit 404 performs a QoS control operation, and the DiffServ control unit 406 provides QoS. The policy based control unit 405 enables the QoS control unit 404 and the DiffServ control unit 406 to perform control operations on the basis of policies. The traffic control DB unit 407 manages a traffic flow control table in which traffic flow control information is recorded. The QoS mapping unit 408 performs a QoS mapping function relating to system resource management so as to provide QoS received from a higher system. Further, the router control unit 400 includes a system managing unit 409 for performing the functions of entire configuration management of the router and system operation and management of the router, and an eGSMP master unit 410 for performing an open programmable function. Both the system managing unit 409 and the eGSMP master unit 410 communicate with a switching platform 412 through a local bus 411.

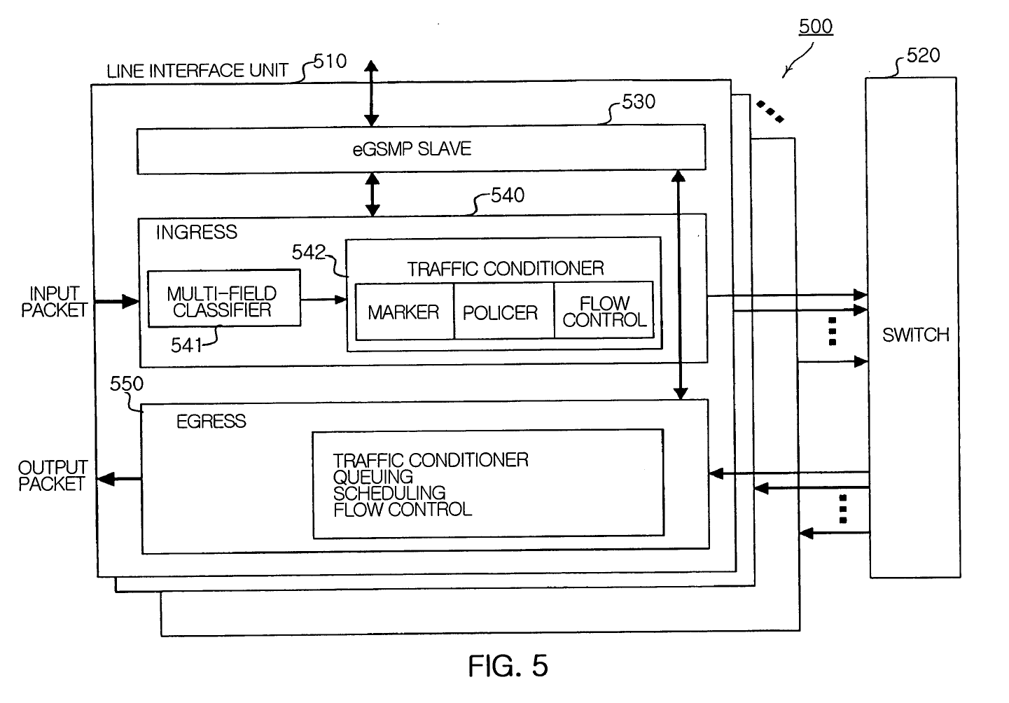

FIG. 5 is a detailed block diagram of the switching platform in the router according to the present invention. The switching platform 500 comprises an IP packet switch 520, and a plurality of line interface units 510 connected to the IP packet switch 520. Each of the line interface units 510 comprises an eGSMP slave unit 530, an ingress processing unit 540 and an egress processing unit 550. The eGSMP slave unit 530 communicates with the router control unit through a local bus so as to provide an open programmable control function to provide QoS. The ingress processing unit 540 and the egress processing unit 550 are connected to the eGSMP slave unit 530 to perform the packet forwarding function including a DiffServ based QoS function. If a packet is inputted to the ingress processing unit 540, the inputted packet is transmitted to an ingress processing unit of a line interface unit corresponding to a destination IP address by the IP packet switch 520 through a multi-field classifier 541 and a traffic conditioner 542 within the ingress processing unit 540. The traffic conditioner 542 performs marker, policer and flow control functions. The egress processing unit 550 of the line interface unit 510 performs a traffic conditioning function, queuing and scheduling functions, and a flow control function for a packet inputted through the IP packet switch 520. Further, the egress processing unit 550 outputs the packet through an Ethernet physical interface. If the inputted packet is a voice data packet using VoIP, the egress processing unit 550 assigns a high class to the packet on the basis of DiffServ, and provides higher QoS to the packet relative to other data packets. In this case, in order to determine whether the inputted packet is a voice data packet, the line interface unit 510 receives session information provided with QoS from the router control unit, manages the received session information, and uses the session information when the forwarding function is performed.

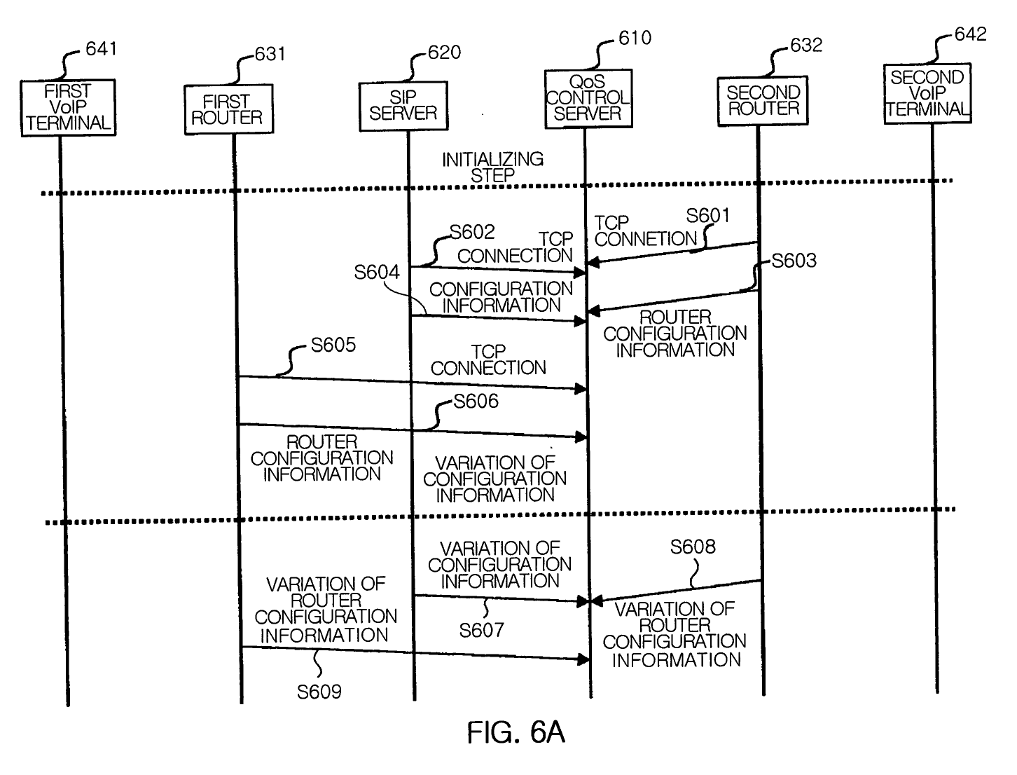

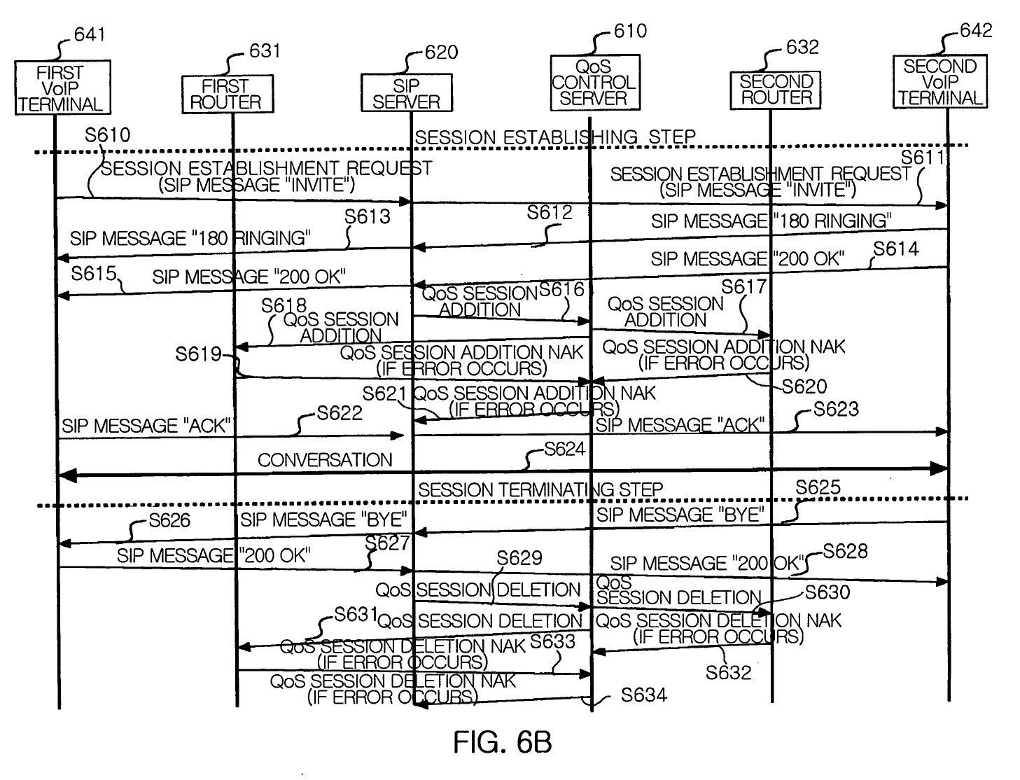

FIGS. 6A and 6B are flowcharts of a method of providing QoS to VoIP packets according to an embodiment of the present invention, wherein a SIP server is used as a VoIP call control device. An entire system for providing VoIP with QoS comprises a SIP server 620, a QoS control server 610, first and second routers 631 and 632, and VoIP terminals 641 and 642. The QoS control server 610 sends QoS session addition/deletion information between the routers 631 and 632. The first and second routers 631 and 632 receive QoS session information from the QoS control server 610 and provide corresponding QoS to a packet. The VoIP terminals 641 and 642 are connected to the routers 631 and 632, respectively. The embodiment of the present invention, implemented by the operations of the above-described elements, comprises an initializing step, a session establishing step, a conversation step and a session terminating step.

FIG. 6a illustrates the initializing step according to an embodiment of the present invention. Referring to FIG. 6a, the SIP server 620 and all routers 631 and 632 in a domain set up TCP connections to the activated QoS control server 610 using TCP ports at steps S601, S602 and S605. In this case, each of the routers 631 and 632 informs the QoS control server 610 of its router configuration information at steps S603 and S606. The SIP server 620 informs the QoS control server 610 of its configuration information at step S604. The configuration information, which includes an interface IP address and mask information of the router, is used to find a corresponding router using source and destination IP addresses included in the QoS session addition/deletion message received from the SIP server 620. If the router configuration information of the routers 631 and 632 and the configuration information of the SIP server 620 vary, the routers 631 and 632 and the SIP server 620 resend messages containing the varied configuration information to the QoS control server 610 at steps S607, S608 and S609, and the QoS control server 610 updates the configuration information.

FIG. 6b illustrates the session establishing step, the conversation step, and the session terminating step according to the present invention. First, when the first VoIP terminal 640, using the first router 631 as a default router, desires to make a call to the second VoIP terminal 642, using the second router 632 as a default router, through VoIP, the first VoIP terminal 641 does not know where the second VoIP terminal 642 logs on. Therefore, the first VoIP terminal 641 requests the SIP server 620 to establish a session by routing an “INVITE” message to the SIP server 620 at step S610. The SIP server 620 receiving the session establishing request performs a Domain Name System (DNS) lookup operation so as to find a SIP Uniform Resource Locator (URL) domain name of the second VoIP terminal 642. Accordingly, the SIP server 620 searches a database for the IP address of the second VoIP terminal 642 and sends an “INVITE” message to the IP address of a called party (second VoIP terminal 642) at step S611. At this time, if a proxy server, which manages a called party's domain, exists, the SIP server 620 sends the “INVITE” message to an IP address of the corresponding proxy server. The second VoIP terminal 642 receiving the “INVITE” message sends a “180 ringing” message to the SIP server 620 at step S612. The SIP server 620 sends a response message to the first VoIP terminal 641 with reference to route indicating information indicated in a header of the received “180 ringing” message at step S613. Thereafter, the second VoIP terminal 642 sends a “200 OK” message to the SIP server 620 at step S614. The SIP server 620 modifies route information in the header of the “200 OK” message, and then sends the modified “200 OK” message to the first VoIP terminal 641 at step S615.

Thereafter, the SIP server 620 sends a QoS session addition message to the QoS control server 610 so as to establish a new session to which QoS will be provided at step S616. The QoS control server 610 receiving the QoS session addition message sends the QoS session addition message to routers 631 and 632, to which transmission and reception terminals belong, respectively, using source and destination IP addresses of the received QoS session addition message at steps S617 and S618. The routers 631 and 632 receiving the QoS session addition message perform QoS setup to provide DiffServ based QoS using the QoS session addition message. At this time, in order for the QoS control server 610 to find routers, to which the transmission and reception terminals belong, using the source and destination IP addresses, the router configuration information received from all routers within the domain by the QoS control server 610 at the initializing step is used.

If the requested QoS setup fails at the routers 631 and 632, the routers 631 and 632 each send a “NAK” message to the QoS control server 610 at steps S619 and S620. The QoS control server 610 may send the “NAK” message to the SIP server 620. Whether the SIP server 620 processes a case where the SIP server 620 receives the “NAK” message is indicated in the configuration information of the SIP server 620 and this information is sent to the QoS control server 610 at the initializing step. If a QoS session requested by the SIP server 620 from the QoS control server 610 requires the provision of QoS, the SIP server 620 determines whether to terminate or maintain the established session according to policies.

After receiving the “200 OK” message from the SIP server 620, the first VoIP terminal 641 sends an “ACK” message to the SIP server 620 using the header of the “200 OK” message at step S622. The SIP server 620 resends the “ACK” message to the second VoIP terminal 642 at step S623, thus completing he establishment of the QoS session.

As described above, after the QoS session establishment and the QoS setup of the routers are completed, the transmission of media for VoIP between two subscribers is directly carried out between the first and second VoIP terminals 641 and 642 without using the SIP server 620 at step S624. At this time, since the routers provide QoS on the basis of DiffServ, ingress and egress routers of the session perform a DiffServ marking function according to the above procedure. Further, a middle node router obtains only a DiffServ code point (DSCP) value marked by the ingress router from an IP header and processes the DSCP value, so a process of transmitting session information is simple relative to a method of reserving QoS in response to a RSVP signal that performs a reservation protocol in a hop by hop manner.

Finally, in the session terminating step, a called or calling party's terminal (that is, the first VoIP terminal or second VoIP terminal) sends a “BYE” message to the SIP server 620 so as to terminate the session when the conversation between the calling and called parties is finished at step S625. The SIP server 620 resends the “BYE” message to an opposite party's terminal at step S626. The terminal receiving the “BYE” message sends a “200 OK” message to the SIP server 620 as a response to the “BYE” message at step S627. The SIP server 620 sends the “200 OK” message to the terminal which sent the “BYE” message at step S628. When the SIP server 620 receives the “BYE” message, the SIP server 620 sends a message for requesting the deletion of the QoS session to the QoS control server 610 at step S629. The QoS control server 610 receiving the QoS session deletion message sends the QoS session deletion message for the corresponding QoS session to the routers connected to the transmission and reception terminals, that is, the first and second routers 631 and 632 at steps S630 and S631. The first and second routers 631 and 632 receiving the QoS session deletion message delete the corresponding QoS session which was previously established, thus completing the session terminating step. At this time, if an error occurs when the first or second router 631 or 632 deletes the QoS session, the first or second router 631 or 632 sends a “NAK” message to the QoS control server 610 so as to inform the QoS control server 610 of the occurrence of the error at step S632 and S633. The QoS control server 610 sends the “NAK” message to the SIP server 620. As an example of the error, there may be a case where a session which the first or second router 631 or 632 is requested to delete does not exist. This case corresponds to a case where a corresponding session is previously deleted or the session is not originally established. In the above procedure, a signal protocol, such as H.323, may be used in place of the SIP protocol using the SIP server 620, such that the above procedure can be similarly performed. Meanwhile, when a call is set up by the SIP server 620, the QoS setup in the IP network consisting of routers can be performed by a QoS session addition request through the QoS control server after a SIP call setup is first completed, as shown in FIG. 6b. However, there can be used a method of first performing QoS session establishment when a call setup request is received from a terminal at the time of processing of a SIP call, and next completing a SIP call setup procedure.

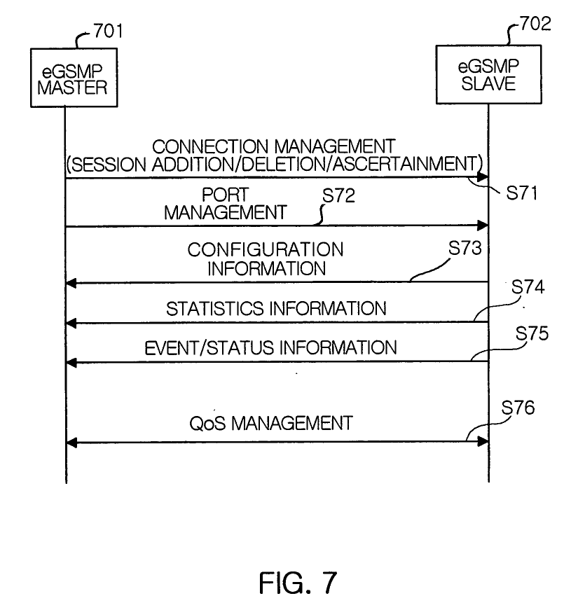

FIG. 7 is a data flow diagram showing the example of an open interface between the router control unit and the switching platform in the router according to the present invention. The enhanced General Switch Management Protocol (eGSMP) is used as a protocol for the open interface that provides QoS between the router control unit and the switching platform. In this case, the eGSMP is a protocol newly defined to allow a conventional GSMP standardized from an Asynchronous Transmission Mode (ATM) to be used in an IP based switched router. The eGSMP has a master-slave structure. As described above with reference to FIGS. 3 to 5, an eGSMP master 701 is operated in the router control unit, and an eGSMP slave 702 is operated in the line interface unit within the switching platform. Main functions of the eGSMP include a connection managing function S71 of performing the addition, deletion, ascertainment or the like of a QoS session for an IP flow, a port managing function S72, a router configuration information managing function S73, a router statistics information managing function S74, an event/status information managing function S75, and a QoS managing function S76. In the present invention, since the eGSMP master and the eGSMP slave communicate with each other through the local bus as described above, the communication between the master and the slave can be achieved regardless of a physical interface.

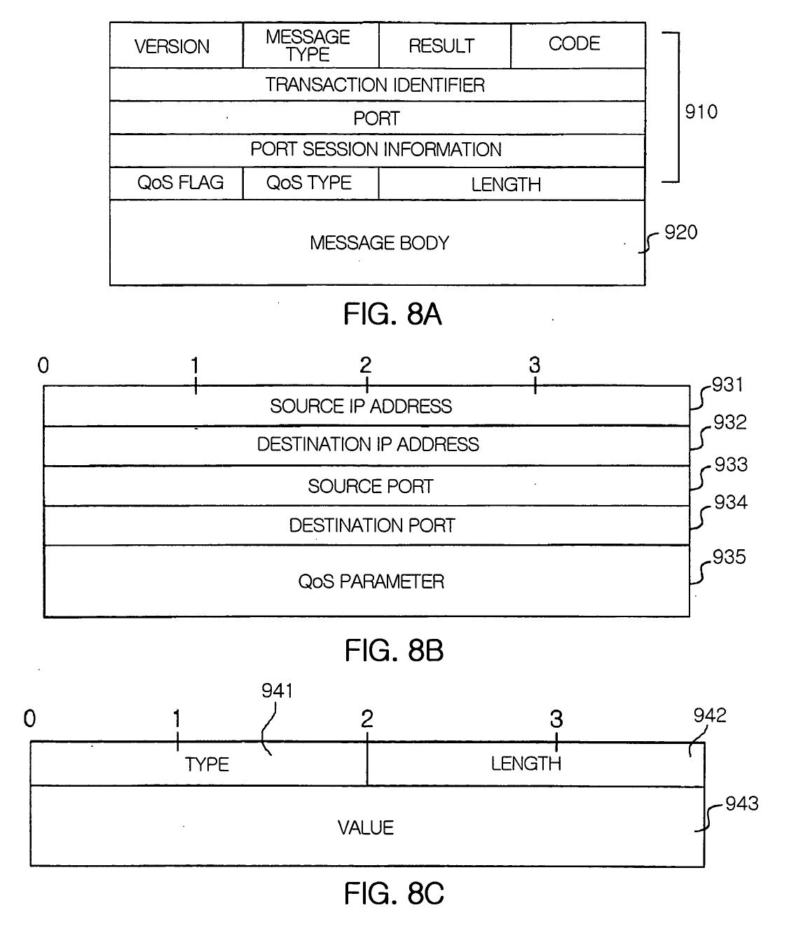

FIGS. 8a and 8c are views showing the exemplary formats of an eGSMP message according to the present invention. FIG. 8a illustrates the entire format of the eGSMP message, wherein the eGSMP message includes a header part 910 and a body part 920. The header part 910 includes information fields for a message version, a message type, a message result, code information, a transaction identifier, a port, port session information, a QoS flag, a QoS type, and a message length. FIG. 8b illustrates an example of a QOS session addition/deletion message. In this case, the QoS session addition/deletion message includes information fields for a source IP address 931, a destination IP address 932, a source port 933, a destination port 934, and a QoS parameter 935 to allow a corresponding session to be classified. FIG. 8c illustrates the format of the QoS parameter 935 in the QoS session addition/deletion message. In this case, the QoS parameter 935 includes information fields for a QoS type 941, a length of a QoS value 942, and a QoS parameter value 943 valid by the length. The QoS parameter 935 is designed to define and use a new QoS type according to requirements.

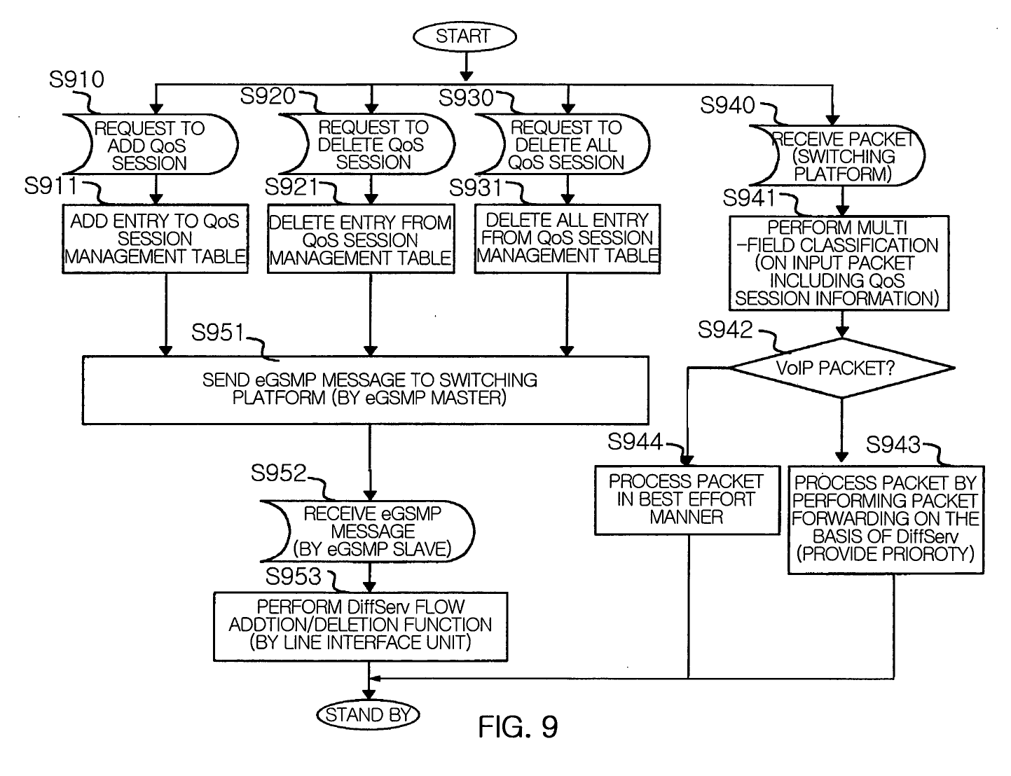

FIG. 9 is a flowchart showing the operation of the router according to the present invention. Referring to FIG. 9, when the router receives a QoS session addition request from the VoIP call control device at step S910, the router control unit of the router adds an entry for the requested QoS session to a QoS session management table at step S911. Further, the router control unit sends a QoS session addition message to the line interface unit through the eGSMP master at step S951. The line interface unit receives the QoS session addition message through the eGSMP slave and performs the operations of multi-field packet classification, queuing, scheduling, and flow control so as to provide QoS on the basis of DiffServ to a corresponding session at step S953. In this case, the eGSMP protocol is used between the eGSMP master and the eGSMP slave. Further, QoS can be provided even on a routing path to a Real Time Protocol (RTP) session established between VoIP terminals.

Similarly, if the router receives a QoS session deletion request from the VoIP call control device at step S920, the router control unit deletes an entry for the deletion-requested QoS session from the QoS session management table at step S921, and sends a QoS session deletion message to the line interface unit through the eGSMP master at step S951. The line interface unit receives the QoS session deletion message through the eGSMP slave and deletes a DiffServ flow for a corresponding session at step S953. Further, when the router receives an all QoS sessions deletion request from the VoIP call control device at step S930, the router control unit deletes entries for the all QoS sessions from the QoS session management table at step S931, and sends an all QoS sessions deletion message to the line interface unit through the eGSMP master at step S951. The line interface unit receives the all QoS sessions deletion message through the eGSMP slave and deletes DiffServ flows for all sessions at step S953.

Meanwhile, if a packet is inputted to the router at step S940, the router control unit performs a multi-field classification function on the input packet including QoS session information at step S941. Through the multi-field classification function, the router control unit determines whether the inputted packet is a packet of a session established using VoIP at step S942. If it is determined that the inputted packet is the packet of a session established using the VoIP, a packet forwarding function of a high QoS class is performed on the packet on the basis of DiffServ at step S943. On the other hand, if the inputted packet is not a packet of a session established using the VoIP, the packet is processed in a best effort manner at step S944.

Further, the present invention can also provide QoS in multimedia sessions, in which voice and video data are contained together, on the basis DiffServ in the same manner as the above process.

As described above, the present invention provides a method of a method of providing DiffServ based QoS to VoIP packets through a router, which provides VoIP session information to source and destination routers establishing a session, without providing VoIP session information to all routers, when a router provides DiffServ based QoS to VoIP voice packets. Further, the present invention adds VoIP flows and QoS information to a flow table for performing a packet forwarding function, and transmits the flow table to a middle router. Accordingly, the present invention is advantageous in that it can recognize VoIP packets and provide QoS to the VoIP packets by simply sharing session information. Further, the present invention is advantageous in that a router first calculates voice traffics with respect to all traffics and reserves corresponding resources while considering the maximum number of VoIP call setups to which the router must provide QoS, thus enabling voice packets of high quality to be transmitted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing Differentiated Service (DiffServ) based Quality of Service (QoS) to Voice over Internet Protocol (VoIP) packets through a router in an Internet protocol (IP) network, the IP network comprising routers, a VoIP call control device for performing a call processing function on the basis of a VoIP signal, and a QoS control server for providing QoS, the method comprising the steps of:
a) providing VoIP call session information including source and destination IP addresses, source and destination user datagram protocol (UDP) port numbers, and requested QoS information to the QoS control server by the VoIP call control device;
b) finding source and destination routers using the VoIP call session information and sending the VoIP call session information requiring provision of QoS to the source and destination routers by the QoS control server; and
c) providing DiffServ based QoS to packet flows by the aggregate of packet flows using the VoIP call session information at the time of VoIP packet forwarding by the routers.

2. The method of providing DiffServ based QoS to VoIP packets through a router according to claim 1, wherein said routers are open programmable switched routers which are capable of providing QoS to VoIP packets.

3. The method of providing DiffServ based QoS to VoIP packets through a router according to claim 1, wherein:
said routers, said VoIP call control device and said QoS control server are designed in a clients-server structure such that both said routers and VoIP call control device are operated as clients, and said QoS control server is operated as a server; and
said routers, said VoIP call control device and said QoS control server are connected to each other in a TCP connection manner through an open application programming interface.

4. The method of providing DiffServ based QoS to VoIP packets through a router according to claim 1, wherein the step b) is performed such that, if router interface configuration information of each of said routers is initialized and modified, said QoS control server receives the router interface configuration information from a corresponding router, manages the router interface configuration information, and uses the router interface configuration information to find a corresponding router at the time of receiving a QoS session addition/deletion request.

5. The method of providing DiffServ based QoS to VoIP packets through a router according to claim 1, wherein the step c) comprises the steps of:
classifying VoIP packets flows requiring provision of QoS using connection setup/disconnection information on end-to-end flows of a VoIP call contained in the received VoIP call session information by said routers; and
providing DiffServ based QoS to the classified VoIP packet flows by the aggregate of packet flows.
